(19) United States
(12) Patent Application Publication
(10) Pub. No.: US 2020/0290205 A1
(43) Pub. Date: Sep. 17, 2020

(54) SAFEGUARDING A MACHINE

(71) Applicant: SICK AG, Waldkirch (DE)

(72) Inventors: Markus HAMMES, Waldkirch (DE); Christoph HOFMANN, Waldkirch (DE)

(21) Appl. No.: 16/814,258

(22) Filed: Mar. 10, 2020

(30) Foreign Application Priority Data
Mar. 11, 2019 (EP) 19161892.5

(51) Int. Cl. B25J 9/16; G05B 19/042; G05D 1/02

(52) U.S. Cl. CPC B25J 9/1676; G05B 19/0428; G05B 2219/40548; G05B 2219/40613; G05D 1/0214

(57) ABSTRACT

A safety system for safeguarding a machine is provided, said safety system having at least one safe sensor for producing safe data, wherein the safe sensor also produces non-safe data and/or a non-safe sensor for producing non-safe data is provided, wherein the safety system furthermore has a non-safe evaluation unit for processing the non-safe data and a safe evaluation unit that is configured to test the non-safe evaluation unit in that an evaluation result of the processing of the non-safe data is checked with reference to the safe data, The safe data have a lower accuracy and/or are more rarely available in comparison with the evaluation results.

The invention relates to a safety system for safeguarding a machine, said safety system having at least one safe sensor for producing safe data, wherein the safe sensor also produces non-safe data, and/or having a non-safe sensor for producing non-safe data, wherein the safety system furthermore has a non-safe evaluation unit for processing the non-safe data and a safe evaluation unit that is configured to test the non-safe evaluation unit in that an evaluation result of the processing of the non-safe data is checked with reference to the safe data. The invention further relates to a method of safeguarding a machine in which safe data are produced from at least one safe sensor and non-safe data are produced from the safe sensor and/or from a non-safe sensor, wherein the non-safe data are processed in a non-safe manner and the non-safe processing is tested in that an evaluation result of the processing of the non-safe data is checked with reference to the safe data.

A safety system of this kind uses one or more sensors to monitor the environment of a machine and to switch it to a safe state in good time when there is impending danger. A laser scanner is a sensor frequency used for this purpose. In this respect, a light beam generated by a laser periodically sweeps over a monitored zone with the help of a deflection unit. The light is remitted at objects in the monitored zone and is evaluated in the laser scanner. A conclusion is drawn on the angular location of the object from the angular position of the deflection unit and additionally on the distance of the object from the laser scanner from the time of flight while using the speed of light. The location of an object in the monitored zone is detected in two-dimensional polar coordinates using the angular data and the distance data. The third spatial coordinate can also still be detected by a relative movement in the transverse direction, for example by a further degree of freedom of movement of the deflection unit in the laser scanner or in that the object is moved relative to the laser scanner.

In a safety engineering application for safeguarding a machine, the laser scanner monitors a protected field which may not be entered by an operator during the operation of the machine. If the sensor recognizes an unauthorized intrusion into the protected field, for instance a leg of an operator, it triggers an emergency stop of the machine. Sensors used in safety engineering have to work particularly reliably and must therefore satisfy high safety demands, for example the standard EN13849 for safety of machinery and the machinery standard EN1496 for electrosensitive protective equipment (ESPE). To satisfy these safety standards, a series of measures have to be taken such as a safe electronic evaluation by redundant, diverse electronics or different function monitoring processes, especially the monitoring of the contamination of optical components, including a front lens. A safety laser scanner in accordance with such standards is known, for example, from DE 43 40 756 A1.

The exact position information in two-dimensional polar coordinates is only available internally in the safety laser scanner and up to now there have not been any devices that forward this information to the outside in a safe manner. Only the information whether a protected field has been infringed is safely output and this protected field can be freely configured in known laser scanners. Protected fields can also be switched over and there have for some time been laser scanners that simultaneously evaluate a plurality of protected fields and in so doing indicate which of the protected fields has been infringed.

The protected field evaluation of a laser scanner is a typical example for a discrepancy of the information content between the detected sensor information and the safe output value. An abundance of high quality sensor information is detected internally; in the example of the laser scanner the contour of all the scanned objects, in other sensors the information may be two-dimensional or three-dimensional image data or other sensor data. This sensor information is, however, already filtered in the sensor and is highly compressed in accordance with safety engineering requirements, typically down to only one binary switching signal for a machine control that sets the machine into the safe state if required. The binary switching signal is safe, but contains almost nothing of the initial sensor information. Primarily simple safety functions can thus be implemented such as the starting example of monitoring configured protected fields.

The non-compressed sensor data of high information content are in contrast not forwarded or are only forwarded over non-safe data interfaces to thus implement additional automation functions. No safety applications are possible with them since the transfer of the sensor data and also the subsequent evaluation already do not satisfy said demands of the safety standards.

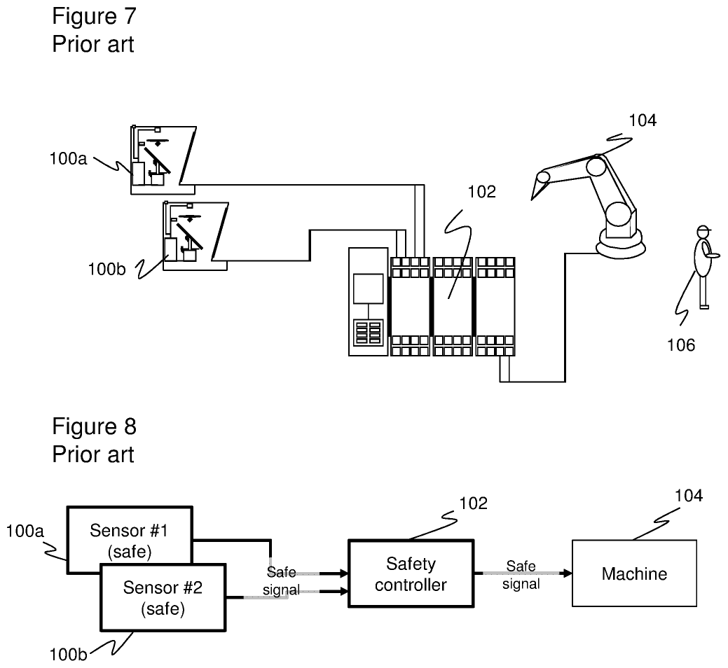

The conventional safety concept is shown with specific hardware components in FIG. 7 and abstractly as a block diagram in FIG. 8. Safe sensors 100a-b, in this example safety laser scanners, are connected to a safety controller 102. The safe switching signals of the safety laser scanners 100a-b are linked there. If a person 106 is at risk in the environment of the monitored machine 104, here an industrial robot, a safeguarding signal is output to the machine 104 to switch the machine 104 into a safe state in good time.

Safety components, that is safe sensors 100a-b, a safety controller 102, and safe signal paths are used at all times here. To be safe, error control measures are separately implemented everywhere there so that possible safety relevant errors along the signal chain are avoided or monitored.

This procedure substantially restricts the flexibility in the implementation of complex safety functions. Three important reasons can account for this: Data interfaces are lacking that can be used in a technical safety manner and that permit sufficiently high data transfers. Otherwise, for example, a safety laser scanner could also safely output its scan data and not only output a binary signal on an infringement of the protected field. Furthermore, high-performance safety controllers are lacking with which complex algorithms can be carried out at acceptable speeds on large data amounts. Only simple links of binary safety signals would thus no longer be possible. Finally, software function blocks are lacking that can be carried out on a control in a manner relating to the application and that would permit a stepwise expansion of the functional extent of safety functions in the field.

EP 2 395 372 B1 discloses an arrangement of a plurality of safety laser scanners that are together connected to a safety controller. In addition to the protected fields, automation fields are monitored, with specific interventions in automation fields triggering a switchover of the protected field configuration. The safety relevant communication of the safety laser scanners is consequently still restricted to binary protected field infringements so that this is an example for the conventional approach explained with respect to FIGS. 6 and 7.

A safeguarding of a hazardous working zone of a machine by means of a stereo camera is described in EP 2 825 812 B1. Objects in a protected field around the machine are detected by a safe foreign object detector. In addition, the image data are used to recognize persons as such in a classifier and then to track them. The person tracking itself is not safely implemented. A check is instead made whether the position determined by the person tracking coincides with that of the foreign object detector and an emergency stop is activated if not. With the safety sensors available on the market, however, including safety laser scanners as described above, it is now actually not possible to output the position information safely, but rather only protected field infringements are provided in binary form. Such a comparison of position information is therefore not possible in practice unless a safety stereo camera is developed in a very dedicated manner under huge effort that has the total functionality of EP 2 825 812 B1 and that then, however, only implements just this one safety concept and is no longer flexible. If in another respect a safety camera could nevertheless already be able to output position information in a safe manner, a plausibilization of this position information is superfluous; it is already safe.

A method and an apparatus for creating an application program for a safety controller is known from WO 2010/094466 A1. Which portion of the program variables is safety relevant and which is not can be configured here and there is accordingly a first program part for a failsafe processing and a second program part for a non-failsafe processing. However, this does not solve the problem of insufficient processing capacities in the safety controller. The non-failsafe processing necessarily remains simple due to limited resources. In addition, it no longer plays any role for the safety concept in accordance with its intended purpose and does not therefore contribute to its flexibility and complexity.

It is therefore the object of the invention to provide a safety system having an improved safety function.

This object is satisfied by a safety system and by a method for safeguarding a machine in accordance with the respective independent claim. The safety system comprises at least one safe sensor that detects the machine or a zone related to the machine such as its environment or an access path and that produces safe data or signals from this sensor information. In this respect, the term safe is to be understood in the sense of the standards named in the introduction or of comparable standards; measures are therefore taken to control errors up to a specified safety level. The safe sensor and/or at least one non-safe sensor moreover produce non-safe data such as raw data, point clouds, or the like. Non-safe is the opposite of safe and accordingly said demands on failsafeness are not satisfied for non-safe devices, transmission paths, evaluations, and the like.

A non-safe evaluation processes the non-safe data. This is a functional branch also for complex and flexible evaluations. Optionally, the safe data can be included, but are only to be understood as an additional portion of the non-safe data in the functional branch. A safe evaluation furthermore checks the result of the non-safe evaluation with the aid of the safe data. This safe test branch or plausibilization branch establishes a required safety level for the total system including the functional branch. In accordance with the safety standards named in the introduction, this corresponds to an accepted single-channel safety architecture with testing.

The invention starts from the basic idea of using safe data for testing whose information content is low with respect to the non-safe data and to the evaluation result found in the functional branch of the non-safe evaluation. The safe data are therefore of less precision and/or are available more rarely in comparison with the evaluation result. The safe data form a kind of grid around the evaluation results by which breakouts are recognized that are too large, but would not be sufficient to verify the evaluation results at all times and with any desired precision. It is here not only a question of tolerances in a comparison, the safe data rather lack in a dedicated manner in accordance with the safe evaluation a depth of information corresponding to the evaluation results from the non-safe data. The safe evaluation evaluated the sensor information with a very specific objective with respect to the safe data and substantially diluted or compressed their information content in so doing. Consequently the safe data in no way replaces the non-safe evaluation; there is simply no redundancy. For example, the safe data have a smaller spatial or temporal resolution, in particular smaller by a factor of n=2 . . . 10or even more, or they are only available at certain times or in certain constellations.

The invention has the advantage that complex safety functions can also be implemented and flexibly adapted. It is not simply only a conventional sensor data merger on the level of simpler safer signals that takes place. There is rather the possibility of first collecting sensor information of different safe and/or non-safe sensors and then to implement a combined safety function. This is based on available hardware modules; it is therefore not necessary to wait for the development of more powerful safety interfaces for the transfer of complex safe data and equally not for safety controllers having substantially more processing power. The total spectrum of safety levels can be mapped using the architecture in accordance with the invention of a safety system, for example performance levels PL-a to PL-d. Safety levels appropriate to the respective application can thus be used and the costs can thus be reduced since overdimensioned safety solutions do not have to be used due to a lack of flexibility that are not even needed in the specific case. It is possible to draw on a huge variety of safe and non-safe sensors and thus to provide a large solution variance.

All the sensors or at least some of the sensors are optoelectronic sensors. This relates both to the safe sensors and to the non-safe sensors since a zone around the machine can be particularly easily monitored therewith.

The safe evaluation unit is preferably configured for the production of a safeguarding signal to the machine if the evaluation result is not plausible. In this case, the test by the plausibilization branch had been failed and the non-safe evaluation had accordingly been recognized as unreliable or an error had been discovered. It is conceivable to tolerate this under predefined criteria, for instance to still wait for a next test cycle. The safety system, however, outputs a safeguarding signal to the machine at the latest at this time, the machine thereupon changing to a safe state, for example stopping, slowing, or evading.

The non-safe evaluation unit is preferably configured for the production of control signals to the machine, in particular to safeguard the machine. The control of the machine by the non-safe evaluation unit explicitly includes the safeguarding as an option if the result of the processing of the non-safe data produces this requirement. The risk of an unrecognized error in the non-safe evaluation unit is limited to the extent of the lacking precision and/or the duration between two tests due to the check of the non-safe evaluation unit by means of the safe evaluation unit. The safety system thus achieves a specified safety level as a whole and including the non-safe evaluation unit observed in isolation.

The safety system preferably has a safety controller having the safe evaluation unit. The safe evaluation unit thus forms a separate device. The safe sensor transfers the safe data to the safety controller. The safety controller is safe, but only has a limited functional extent or limited storage and processing capability as well as a limited spectrum of data interfaces. An implementation as a functional block in the safe sensor is conceivable as an alternative to a separate safety controller.

The safety system preferably has a processor unit having the non-safe evaluation unit. The processor unit is likewise a separate device, but not a safety controller, that is it is not safe. Examples are a non-safe controller or a standard controller, but also an industrial computer having a CPU and/or a GPU as well as a computer network including a cloud. The non-safe data are transferred to the processor unit, either from the safe sensor or from the non-safe sensor. The processor unit is preferably configured for complex evaluations, has a high functional extent, and large storage and processing capacities as well as a large bandwidth of the data interfaces. An implementation as a functional block in the non-safe sensor or also in the safe sensor is conceivable as an alternative to a separate processor unit.

In a further conceivable embodiment, the safe evaluation unit and the non-safe evaluation unit are implemented in a common device. This is, however, not the preferred solution since respective separate hardware modules can be adapted more directly to their respective work.

The safe data preferably have at least one binary object determination signal. The safe data even more preferably only comprise at least one binary object determination signal. This is a typical output value of a safe sensor that in conventional applications is output to the machine as a safeguarding signal directly or indirectly after linking in an interposed safety controller. In the safety system in accordance with the invention, the binary object determination signal is used for testing by the safe evaluation unit and thus acts at best indirectly as a safeguarding signal.

The safe data preferably have information as to whether a protected field has been infringed and which one it is. This typically takes place in the form of binary object determination signals, but is in principle also possible in a different data format. If only one protected field is monitored, its identity is automatically known without the safe data having to include information for this purpose. With a plurality of protected fields, a plurality of outputs are selectively used as a transmission path or a protocol is used that allows the identity of the protected fields to be recognized by specific time slots or other codes.

The safe sensor is preferably configured as a safety laser scanner. With a plurality of safe sensors, at least one thereof is a safety laser scanner; in some embodiments even all the safe sensors are safety laser scanners. In safety engineering, they are very proven sensors having a large detection range that can simultaneously also serve as a source for high quality non-safe data in the form of scan data or object contours or point clouds. Safety laser scanners are in particular able to recognize infringements of one or more configured protected fields and to output corresponding safe data in the form of binary switching signals, for instance. Protected field monitoring processes are, however, also conceivable with other safe optoelectronic sensors, for example with light grids and two-dimensional or three-dimensional cameras as well as with other sensors such as capacitive sensors or pressure mats.

The non-safe evaluation unit is preferably configured to determine the distance of an object from the machine. A distance-based safeguarding of the machine can in particular take place using this distance, with the machine therefore being safeguarded when an object comes too close to the machine. The speed is preferably also determined (speed and separation monitoring). It is preferably not the distance of arbitrary objects that is monitored, but persons or even body parts are rather recognized and at least some known other objects are also permitted close to the machine. It must again be pointed out that this safety relevant evaluation takes place in the non-safe evaluation unit. The safety is produced by the verification by means of the safe evaluation unit.

The safe sensor is preferably configured to monitor a grid of a plurality of protected fields, with the safe data on the identity of an infringed protected field comprising safe position information. Safe comparison data matching a distance monitoring are thus detected. The position of an object in the environment of the machine is safely detected by the grid of safely monitored protected fields with the accuracy of the grid. This position information is coarser than that of the distance monitoring in the non-safe evaluation unit and is output by a few safe data, in particular binary object determination signals. This is, however, sufficient to reveal errors of the non-safe distance monitoring.

The safe evaluation unit is preferably configured to check the evaluation result of the non-safe evaluation unit at a point in time at which the identity of an infringed protected field changes. The test therefore takes place at very specific points in time, with these tests specifically triggered by changes in the recognized protected field infringements supplementing or replacing cyclic tests depending on the embodiment. At that moment at which a protected field is infringed for the first time, the intruding object must be located at its margin. The object position is particularly known with high accuracy even better than the grid of the protected fields when an early protected field infringement of an adjacent protected field is simultaneously no longer present.

The non-safe evaluation unit is preferably configured to navigate a vehicle, preferably an automated guided vehicle (AGV). Depending on the embodiment, this includes the self-localization, pathfinding, environment detection, and safeguarding of the vehicle. The safety system preferably travels with at least some of the sensors, with supplementary stationary sensors and, for example, a non-safe evaluation being conceivable in a cloud outside the vehicle. SLAM (simultaneous localization and mapping) algorithms are used for such navigation work, for example, that are very processing intensive and can therefore not be implemented in a safety controller.

The safe data preferably have some position information at at least one reference position, in particular in that the safe sensor monitors reference protected fields. For the navigation application, they are suitable safe data for testing the non-safe evaluation unit. The non-safely calculated navigation has to reproduce at least the reference positions, with the safety level inter alia being predefined by the frequency of reference positions. Reference positions are particularly preferably acquired in that reference protected fields are checked for infringement at known positions by the safe sensor.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

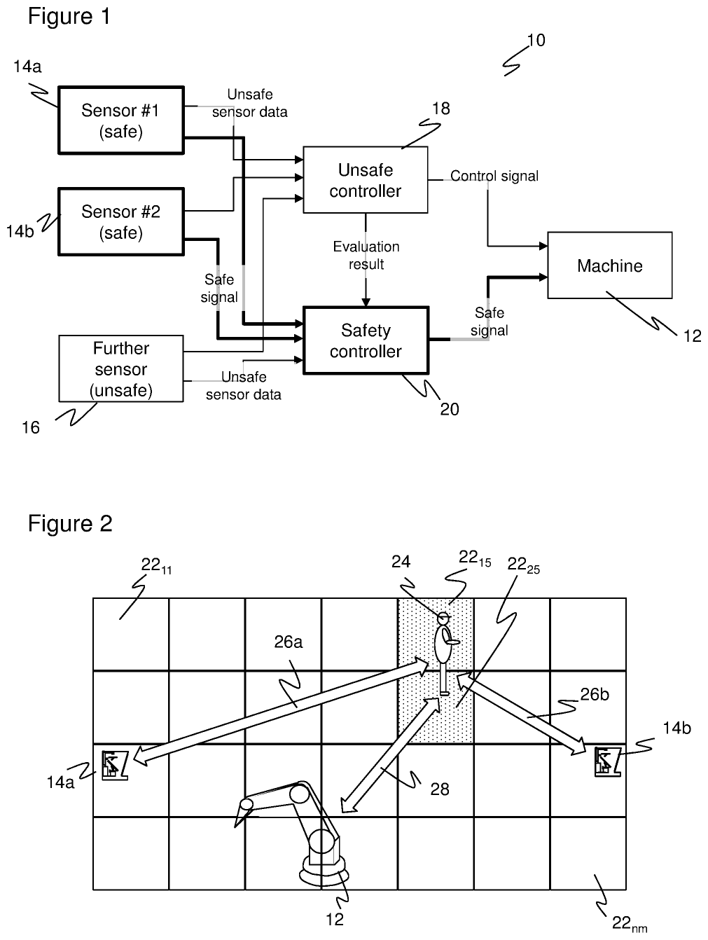

FIG. 1 a schematic block representation of an embodiment of a safety system;

FIG. 2 an exemplary representation of a monitoring of a robot with distance monitoring and a grid of protected fields of two safety laser scanners;

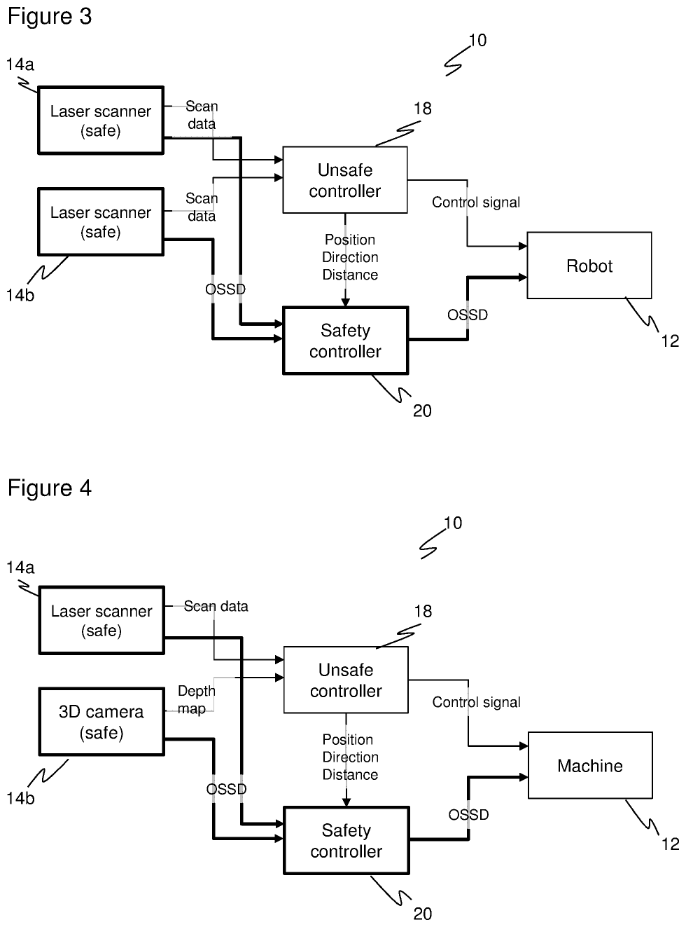

FIG. 3 a schematic block representation of an embodiment of a safety system for the example of FIG. 2;

FIG. 4 a schematic block representation of an embodiment of a safety system for a similar monitoring situation as in FIG. 2, but now with a safety laser scanner and a safety 3D camera;

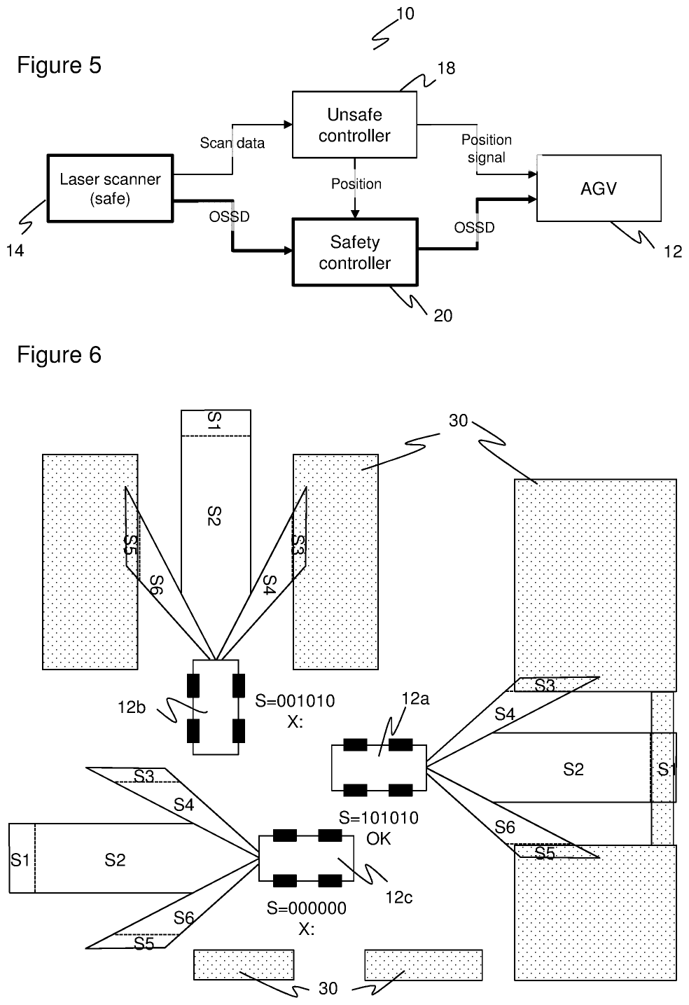

FIG. 5 a schematic block representation of an embodiment of a safety system for the navigation of a vehicle;

FIG. 6 an exemplary representation of a navigation of a vehicle with a position check through protected fields;

FIG. 7 a representation of a conventional safety concept; and

FIG. 8 a schematic block representation of a conventional safety system for the safety concept of FIG. 6.

FIG. 1 shows a schematic block representation of a safety system 10 for safeguarding a machine 12 such as a robot, a vehicle, or another usually complex machine. At least one safe sensor, there are two safe sensors 14a-b in the example, monitors a zone associated with the machine 12 such as its environment or an access path. A non-safe sensor 16 can optionally additionally be provided. The terms safe and non-safe are still to be understood such that corresponding components, transmission paths, and evaluations satisfy or do not satisfy the standardized criteria for safety named in the introduction. The sensors are preferably optoelectronic sensors, for instance laser scanners or camera, but can also be at least in part based on a different sensor principle.

The safety system has a non-safe controller 18 and a safety controller 20 for the evaluation of the different sensor data. They are preferably each per se separate hardware modules, as shown. Alternatively, they could at least partly be functional blocks in the sensors 14, 16 or a common controller 18, 20. The division into safe and non-safe paths would remain here.

The non-safe controller 18 preferably has a high processing power and flexibility and is able to communicate and process large amounts of data. It is, for example, a non-safe standard controller or a CPU or also a GPU in an industrial computer. An edge computing infrastructure or a cloud solution are furthermore conceivable. Since the processing has to be non-safe, approaches from machine learning are also possible such as deep learning and all the variants of neural networks.

The non-safe controller 18 receives and processes non-safe sensor data from the non-safe sensor 16, if present, alternatively or additionally also non-safe data from a safe sensor 14a-b. The non-safe sensor data are typically complex and extensive, for instance images, point clouds, or scan data. The non-safe controller 18 forms a functional branch in which complex evaluations of larger sensor data amounts run. Standard hardware modules can be used for this purpose because no or at most low safety demands have to be satisfied.

The safety controller 20 is in contrast safely configured by two-channel ports, processing paths, and corresponding evaluations. Instead it only offers comparatively simple evaluation possibilities, interfaces with small bandwidth, typically only for binary signals, and limited storage and processing capacities.

The safety controller 20 receives safe data of the safe sensors 14a-b. The safe sensors 14a-b have therefore already substantially reduced or compressed the original sensor data by internal safe evaluation. As a rule, only a binary safe signal is output (OSSD, output signal switching device), in some cases a plurality thereof, to deliver the information as which of a plurality of protected fields monitored in parallel has been infringed. The safety controller 20 optionally also receives non-safe data of the non-safe sensor 16, with the additional redundancy being able to increase the safety level.

The safety controller 20 forms a test branch or a plausibilization branch for the non-safe controller 18. For this purpose, an evaluation result is transferred from the non-safe controller 18 to the safety controller. The evaluation result can, but by no means must, be the desired output value of the non-safe evaluation, but is rather possibly only a portion thereof or even a specific test value that is produced in the actual evaluation for the safety controller 20. The safety controller 20 now checks with reference to the safe data whether the evaluation result corresponds to its expectation and thus uncovers possible errors of the non-safe controller 18.

Examples for the evaluation result transferred for test purposes and for the safe data with reference to which the evaluation result is tested will be given further below. The expectation is derived in FIG. 1 from the safe signals of the safe sensors 14a-b. It must be mentioned that different safe system data, for instance safe position information of the machine 12 or process information such as specific dimensions and the like, can equally be used. The respective source of such safe data, in particular the machine 12, is understood as a safe sensor with respect to this roll in such cases.

The non-safe controller 18 produces control signals for the machine 12 from its evaluation. This expressly includes its safeguarding, that is the moving into a safe state because the (initially) non-safe evaluation has recognized a hazard situation. The machine 12 as a rule still has its own controller with which the non-safe controller 18 communicates. The safety controller 20 in turn safeguards the machine 12 with a safe safeguarding signal if the test of the non-safe controller 18 discovered an error. It is also conceivable here in advance to tolerate errors up to a certain degree, for example not to trigger any safety response if the error no longer occurs in the following test cycle. It is conceivable that, without any representation by corresponding arrows, the machine 12 returns information to the non-safe controller 18 and/or to the safety controller 20.

The safety controller 20 thus monitors the non-safe controller 18 with reference to the evaluation result. The machine 12 is primarily controlled by the non-safe controller 18. The safety controller 20 as a rule only as a passive monitoring mechanism checks whether the control signals of the non-safe controller 18 are consistent with the safe data and the expectation derived therefrom. In the case of a deviation or on an occurrence of an implausible evaluation result of the non-safe controller 18, the safety controller 20 can intervene and take over the control of the machine 12. The safeguarding of the machine 12 can mean its stopping or an emergency stop. Other safety relevant maneuvers are path-bound slowing, stopping, and restarting as well as safety relevant evasion maneuvers, which are particularly suitable in the case of robots or AGVs.

The procedure of creating safety by tests is described in principle in the safety standard ISO/EN 13849-1. A single-channel architecture with category 2 testing is achieved with every input, i.e. with a safe sensor 14a-b or with a non-safe sensor 16. Very high safety categories such as category 4 or performance level PL-d can thus also be reached by a plurality of sensors 14a-b, 16. The aim of the invention is, however, not necessarily to satisfy very high safety demands, even if this is possible, but rather flexibility including the most varied safety levels. The specifically reached safety level does not solely depend on the basic architecture of the safety system 10, but also on the safely levels of the sensor 14a-b used and on the evaluations and the plausibilization steps.

In summary, a high performance non-safe controller 18 without any special safety architecture as a functional branch for processing complex sensor data is combined with a simple safety controller 20 as the test branch. The technical safety testing of the non-safe controller 18 is transposed into a separate safety controller 20. Results of the complex sensor data processing in the non-safe controller 18 are checked against an expectation. The safe data can be used as an expectation for validating the evaluation of the non-safe controller 18 due to the technical safety processing into simple safe data such as safe switching signals that has already taken place in the safe sensor. The fact is additionally preferably used that a large number of safe sensors 14a-b deliver both safe switching signals and complex sensor data. Alternatively, an additional non-safe sensor 16 is used as the source of the complex sensor data. In accordance with the invention, previously inaccessible safety functions can be flexibly implemented on an available non-safe controller 18 and safety controller 20 and the high quality sensor information can be utilized better. This concept can be used everywhere that safe or non-safe sensors 14a-b, 16 provide both sensor data and additionally safe data or switching signals as the basis of the plausibility check.

FIG. 2 shows by way of example the monitoring of a robot 12 with the aid of two safety laser scanners 14a-b for implementing a distance monitoring (in particular speed and separation monitoring). FIG. 3 shows the corresponding safety system 10 in a block representation. The safety laser scanners 14a-b monitor a grid of protected fields 22₁₁..22ₙₘ. The regular rectangular grid shown of mutually identical protected fields 22₁₁..22ₙₘ is particularly clear but irregular protected fields of different sizes and arranged with gap are also possible.

An object 24, here a person, is now detected, on the one hand, by the safety laser scanners 14a-b in specific protected fields 22₁₅..22₂₅ and corresponding binary switching signals (OSSD) are transferred to the safety controller 20. In addition, the scan data are evaluated as non-safe sensor data in the non-safe controller 18. In this process, distances from the respective scanner center are calculated by means of object localization such as indicated by arrows 26a-b. The distance of the person or of the object 24 from the robot 12 in accordance with the arrow 28 can then also be derived from this.

The non-safe controller 18 decides which control commands are to be given to the robot 12 and whether a safeguarding is necessary on the basis of the distance of the object 24, that can be recognized as a person or only as an arbitrary object, and possibly on the basis of further values such as the direction and speed of the movement. This evaluation and control is not yet safe up to this point. The non-safe controller 18 therefore transfers evaluation results such as the position, distance, or direction of movement to the safety controller 20.

The safety controller 20, on the other hand, has an expectation at least of the position of the object 24 on the basis of the infringed protected fields 22₁₅, 22₂₅. An interval can be indicated by this in which the position determined by the non-safe controller 18 or the distance of the object 24 has to be disposed to be plausible. If the evaluation result obtained by the non-safe controller 18 is disposed in this interval, the calculated distance value is deemed plausible. Otherwise, the safety controller 20 itself triggers a safety relevant response of the robot 12 as soon as the distance monitoring of the non-safe controller 18 can no longer be considered reliable.

It is particularly advantageous to use a status change of protected fields 22₁₁..22ₙₘ as the trigger for a plausibilization. Status change means that an object 24 is detected in a protected field 22₁₁..22ₙₘ previously not infringed or conversely a protected field 22₁₁..22ₙₘ is no longer infringed. The position of the safety relevant object 24 is actually also particularly exactly known to the safety controller 20 on such a status change since the object 24 then has to be located at the protected field boundary. This point in time is therefore particularly favorable for a plausibilization.

FIG. 4 shows a modified further embodiment of the safety system 10 in which a safe 3D camera 14b has replaced the one safety laser scanner 14b. The safety laser scanner 14a, for example, has a high safety level SIL 2 or PL-d and the 3D camera 14b has a medium safety level PL-c. The 3D camera could alternatively also be non-safe. The non-safe controller 18 in turn has the object of determining the distance between the machine 12 and the object 24 from the non-safe data of the 3D camera, in particular from a depth map, and possibly additionally from the scan data of the safety laser scanner 14a and, optionally from the process data of the machine 12. The distance is compared with a less exact, but very safely known expected value in the safety controller 20 and is thus upgraded in a technical safety aspect. Further evaluation results such as the direction of movement or the speed can be determined in the non-safe controller 18 and can be plausibilized in the safety controller 20.

As in the example of FIG. 2, a grid of protected fields can again be monitored to derive the expected value and the comparison for the plausibilization can in particular be initiated actually at the time of a signaled protected field change. The high quality safety function of a three-dimensional speed and separation monitoring at a high safety level can be implemented using such a safety system 10.

FIG. 5 shows a schematic block representation of a further embodiment of the safety system 10 for the safe navigation of a vehicle, specifically of an at least partly autonomous vehicle (AGV—automated guided vehicle). An embodiment is shown having only one safety laser scanner 14, with alternatively a plurality of safety laser scanners and also other scanners such as cameras and the like being able to be used.

The navigation task requires the use of very complex processes such as SLAM (simultaneous localization and mapping), which a safety controller 20 could not provide at all with its limited resources. Since the non-safe controller 18 in principle makes use of arbitrary hardware, such algorithms can be implemented there.

The safety controller 20 in turn has the object of validating the evaluation results, in particular of confirming positions on the basis of protected field states of the safety laser scanner 14. The non-safe controller 18 for this purpose, possibly without being shown in FIG. 5, sends triggers or switchover signals for changing protected field configurations back to the safety laser scanner 14.

Test positions can be configured in the working zone of the vehicle 12 at which test positions unambiguous environmental features are checked as to presence and at least rough position by special reference protected fields. FIG. 6 shows as an application example the navigation of a vehicle 12a-c in three different positions in a warehouse with environmental objects 30 such as racks, walls, and the like. A safety laser scanner, not drawn, at the front of the vehicle 12a-b monitors six simultaneous protected fields S2-S6 that are programmed such that a very specific combination that is as unambiguous as possible of infringed and not infringed protected fields S1-S6 or a corresponding OSSD combination of the safety laser scanner is present at a reference position, for instance at a transfer point, here the vehicle 12a.

Safe data are, for example, transferred from the safety laser scanner to the safety controller 20, said safe data forming a six-digit bit pattern corresponding to the exemplary six protected fields S1-S6 here and in which an associated bit is set to zero when the protected field is free and to one when it has been infringed. Only the vehicle 12a at the reference position will accordingly deliver the reference bit pattern S=101010, while with vehicle 12b where S=001010, the protected field S1 remains free unlike at the reference position, and with vehicle 12c where S=000000, all the protected fields are even free. At least one bit thus does not coincide with the expectation for the reference position at every position except for vehicle 12a. The safely determined reference position in the safety controller 20 can thus verify the position of the non-safe controller 18 determined via SLAM, for example, in the position of the vehicle 12a.

This position confirmation can be completely mapped in the safe test branch of the safety controller 20. The safety laser scanner monitors the configured reference protected fields S1-S6 and delivers safe switching signals to the safety controller 20. The evaluation result delivered by the non-safe controller 18 is compared with the position known on the basis of the configuration of the reference protected fields and is confirmed with respect to the trigger times that are derived from the status of the reference protected fields and whose position is exactly known.

This is therefore a further example of how complex non-safe evaluations can be verified by transmission of fewer extremely compressed safe data. The safe data are only a bit pattern of a short length from object determination signals or protected field infringements. The length here corresponds to the number of simultaneously monitored protected fields and thus typically amounts to at most ten, at most twenty, at most fifty, or at most one hundred. Particularly with a higher number of protected fields to be configured, the system can provide an automatism to fix protected fields or to at least suggest them. For example, the vehicle 12a could be moved into the reference position and the respective overhang of the protected fields S1, S3, S5 with respect to the protected fields S2, S4, S6 at the border to the environmental objects 30 is automatically fixed.

Validations of the position preferably take place at positions that are particularly critical from a technical safety aspect, for instance where a transfer takes place such as in FIG. 6 or where specific safety functions are shut down (muting) or protected fields are switched over. The trigger can also be produced by the non-safe controller 18 from the determined position data, but a watchdog monitoring is then required. The status change of one or more reference protected fields can also be used as the trigger for a validation in the example of FIG. 5. The advantage again comprises the fact that the position of the vehicle 12 is also particularly exactly determined without SLAM at the time of the status change.

Alternatively or additionally to a safety system 10 with only a safety laser scanner 14 as in FIGS. 5 and 6, a localization and navigation could also take place with other sensors, for instance on a radio basis by means of UWB (ultra-wideband). Such a sensor could naturally itself be formed as safe with a high effort, but preferably complements the safety system 10 as an optional non-safe sensor 16 as in FIG. 1. In the navigation with such a non-safe sensor 16, the position information is then not only produced in a non-safe manner and evaluated in the non-safe controller 18, but is also still transmitted back to the vehicle 12 via a non-safe radio interface. The safety controller 20 of the vehicle 12 can then check with the aid of the reference protected fields described here whether the non-safely determined position is correct at the critical point at which the protected fields, for example, have to be switched over to move into a track.

1. A safety system for safeguarding a machine, said safety system having at least one of at least one safe sensor for producing safe data, with the safe sensor also producing non-safe data, and a non-safe sensor for producing non-safe data, wherein the safety system furthermore has a non-safe evaluation unit for processing the non-safe data and a safe evaluation unit that is configured to test the non-safe evaluation unit in that an evaluation result of the processing of the non-safe data is checked with reference to the safe data, and wherein the safe data have a lower accuracy and/or are more rarely available in comparison with the evaluation result.

2. The safety system in accordance with claim 1,
wherein the safe evaluation unit is configured for the production of a safeguarding signal to the machine if the evaluation result is not plausible.

3. The safety system in accordance with claim 1,
wherein the non-safe evaluation unit is configured for the production of control signals to the machine.

4. The safety system in accordance with claim 3,
wherein the non-safe evaluation unit is configured for the production of control signals to safeguard the machine.

5. The safety system in accordance with claim 1,
that has a safety controller having the safe evaluation unit.

6. The safety system in accordance with claim 1,
that has a processing unit having the non-safe evaluation unit.

7. The safety system in accordance with claim 1,
wherein the safe data have at least one binary object determination signal

8. The safety system in accordance with claim 1,
wherein the safe data have information on whether a protected field has been infringed and on which it is.

9. The safety system in accordance with claim 1,
wherein the safe sensor is configured as a safety laser scanner.

10. The safety system in accordance with claim 1,
wherein the non-safe evaluation unit is configured to determine the distance of an object from the machine

11. The safety system in accordance with claim 1,
wherein the safe sensor is configured to monitor a grid of a plurality of protected fields, with the safe data on the identity of an infringed protected field comprising safe position information.

12. The safety system in accordance with claim 11,
wherein the safe evaluation unit is configured to check the evaluation result of the non-safe evaluation unit at a point in time at which the identity of an infringed protected field changes.

13. The safety system in accordance with claim 1,
wherein the non-safe evaluation unit is configured to navigate a vehicle.

14. The safety system in accordance with claim 13,
wherein the safe data have some position information at at least one reference position.

15. The safety system in accordance with claim 14,
wherein the safe data have some position information at at least one reference position in that the safe sensor monitors reference protected fields.

16. A method of safeguarding a machine in which safe data are produced from at least one safe sensor and non-safe data are produced from at least on of the safe sensor and a non-safe sensor, wherein the non-safe data are processed in a non-safe manner and the non-safe processing is tested in that an evaluation result of the processing of the non-safe data is checked with reference to the safe data, and wherein the safe data have a lower accuracy and/or are more rarely available in comparison with the evaluation results.
